(19) United States
(12) Patent Application Publication
(10) Pub. No.: US 2004/0215116 A1
(43) Pub. Date: Oct. 28, 2004

(54) Device and method for massaging genitals

(76) Inventor: Ee Do Kim, Kyungki-Do (KR)

Correspondence Address: BIRCH STEWART KOLASCH & BIRCH, PO BOX 747, FALLS CHURCH, VA, 22040-0747, US

(21) Appl. No.: 10/423,900

(22) Filed: Apr. 28, 2003

(51) Int. Cl. A61H 19/00

(52) U.S. Cl. 601/136

(57) ABSTRACT

A device method are provided for massaging a body area of a user, such as a sphincter muscle of the user. The device includes a basic plate, and a massaging member supported by the basic plate. The massaging member includes an opening disposed in the massaging member, a massaging plate disposed within the opening for smoothly joining with the top surface of the massaging member to move the genital area of the user on the massaging plate in a reciprocating manner, and a mechanism for movably engaging the massaging plate with the massaging member. When the user makes the lower part of the body move on the massaging plate in the reciprocating manner after the user sits on a portion of the massaging plate, the body area of the user is massaged by the massaging plate.

### BACKGROUND OF THE INVENTION

1. Field of the Invention

The present invention relates to a device and method for massaging male genitals and more particularly, to an improved device and method for massaging training sphincter located around a male genital of a human body, for gradually and effectively improving and revitalizing sexual functions of the genital.

2. Description of the Related Art

Various types of devices and methods for massaging male genitals may be known. Generally, when a male gets cold, his sphincter muscle may become constricted and weak. This may cause urinary diseases, premature ejaculations, fistulas, constipation, decline in energy including sexual energy, etc. The sphincter muscle is located around a male genital and anus for shrinking and stretching the muscles around the genital and anus.

Accordingly, to train and strengthen the sphincter muscle, Kegel exercise programs have been developed. Kegel exercise program is a kind of physical exercise and gymnastics for strengthening the sphincter muscle. However, such a conventional Kegel exercise program does not provide a good result in reality.

Also, Korean Utility Model Patent No. 20-234,956 discloses an exercise supplementary device which includes an outer tube, an inner tube movably inserted into the outer tube, and an elastic rubber ring attached to a circumference of the outer tube and attached to the glands of the penis whereby when the inner tube moves up and down, the sphincter muscles of the male genital can be made to shrink and stretch out. However, such a device can give a harmful result to the personal. Further, the method of using this device is inconvenient as well as uncomfortable to a user.

The present inventor is also prosecuting another U.S. patent application, Ser. No. 10/385,682, filed Mar. 12, 2003, which discloses a device and method are provided for massaging a body area of a user, such as a sphincter muscle of the user. The device includes a basic plate, an upper plate supported by the basic plate, and a massaging member mounted on the upper plate. The massaging member includes an opening disposed in the massaging member, a massaging plate disposed within the opening for providing space to move the massaging plate within the opening in a reciprocating manner, and a mechanism for movably engaging the massaging plate with the upper plate. When the massaging plate is moved in the reciprocating manner after the user sits on a portion of the massaging plate, the body area of the user is massaged by the massaging plate.

However, this device should use a motor with an electric power source. Therefore, this device is inconvenient where the electric power source is not, and in this device, the user cannot adjust the height of the massaging plate.

### SUMMARY OF THE INVENTION

Therefore, an object of the present invention is to provide a device and method for massaging a genital of a person, which eliminates the problems and limitations associated with the conventional art.

Another object of the present invention is to provide an improved device and method for massaging the sphincter muscle located near a male genital and anus, for comfortably and effectively improving and revitalizing the sexual functions of the genital.

Still another object of the present invention is to provide a device for massaging male genitals which is simple in structure, inexpensive to manufacture, durable in use, and refined in appearance.

In accordance with an embodiment of the present invention, a device for massaging a body area of a user, comprising: a basic plate; an upper plate supported by the basic plate; a massaging member mounted on the upper plate, the massaging member including an opening disposed in the massaging member, a massaging plate disposed within the opening, whereby when the user makes to move his body on the massaging plate in the reciprocating manner after the user sits on a portion of the massaging plate, the body area of the user is massaged by the massaging plate.

In accordance with an embodiment of the present invention, a method of massaging a body area of a user, the method comprising: sitting on a portion of a massaging member supported on an upper plate, the massaging member including a massaging plate and an opening to move the massaging plate within the opening; gripping a handle supported on the upper plate; making the user's body to move on the massaging plate within the opening in a reciprocating manner; and massaging the body area of the user by the movement on the massaging plate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a device for massaging a genital area of a user according to an embodiment of the present invention;

FIG. 2 is an explored elevational view of FIG. 1, containing cut-away portions in order to illustrate the construction of the device of the present invention;'

FIG. 3 is a side elevational view of a device for massaging a genital area of the user, containing cut-away portions in order to illustrate the construction of the device according to a second embodiment of the present invention;

FIG. 4 is a perspective view of a device for massaging a genital area of a user, according to a third embodiment of the present invention; and

FIG. 5 is a bottom sectional view of FIG. 4, taken along lines A-A of FIG. 4.

### DETAILED DESCRIPTION OF THE PREFERRED EMBODIMENTS

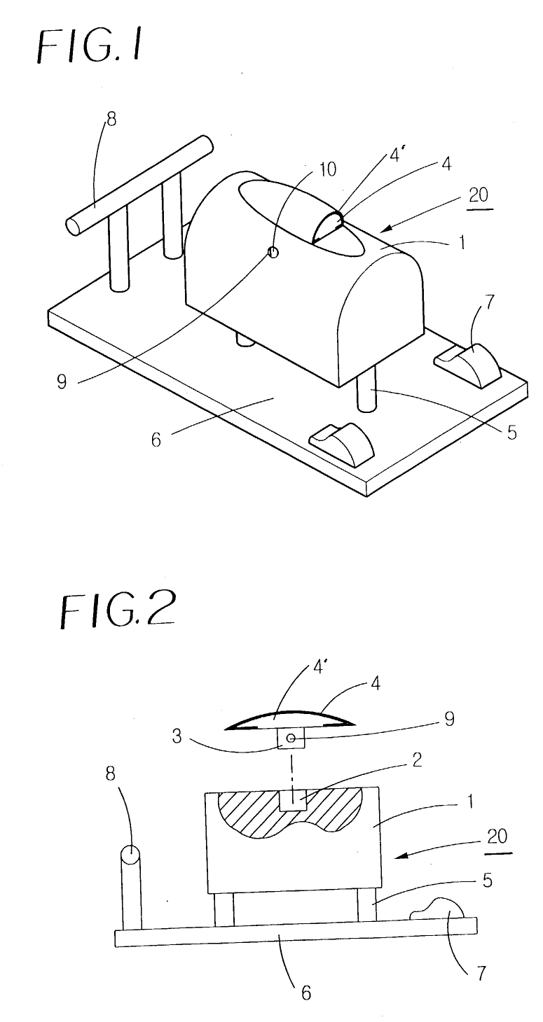

Referring now in detail to the drawings for the purpose of illustrating preferred embodiments of the present invention, a device 20 for massaging genitals (or genital areas) according to an embodiment of the present invention as shown in FIGS. 1 and 2, includes: a massaging member 1, a basic plate 3 for supporting the massaging member 1 thereon, through a plurality of supports 5, a handle 8 located at a higher end portion of the basic plate 3 compared with the massaging member 1, and a pair of foot supports 7 mounted on the other end portion about the handle 8.

As shown in FIGS. 1 and 2, the massaging member 1 having a curved or rounded top surface, includes an opening 2 (e.g., in the rectangular shape) disposed in the center or a predetermined location of the massaging member 1; a massaging plate 4 disposed within the opening 2 and on which a user sits; a projection 3 extended from the massaging plate 4 for inserting into the opening 2; a fixing rod 10 for inserting into a first aperture 9 disposed at the massaging member 1, and a second aperture 9′ disposed at the projection 3 so as to secure the massaging plate 4 to a top of the massaging member 1.

In the present example, the massaging plate 4 has to join with the top surface of the massaging member 1 for moving the genitals of the user on the massaging plate 4 in a reciprocating manner. In one example, the massaging plate 4 has a curved top surface and a massaging cover 4′ adhered on the curved top surface for smoothly accelerating or decelerating the reciprocating movement speed of the massaging plate 12. Further, an additional cover or cushion 4′ may be provided at a face area of the massaging plate 4 (FIG. 2). The face area is an area where the user's genital area comes into contact. The massaging cover 4′ and the cushion may be a sponge, a cloth, or the like.

The handle 8 is located a higher end portion of the massaging member 1 and is supported on the basic plate 6, so as to allow the user to grip the handle 8 before, during or after the use of the device 20. The handle 8 provides support and stability to the user during the massaging operation of the device 20. A timer (not shown) can be disposed on the handle 8 anywhere the user can see. The timer is a conventional time and can have a conventional electric power on/off switch, an overload cut switch, and miscellaneous control switches.

Referring to FIGS. 1 and 2, the device 20 operates as follows. After the user sits on the massaging plate 4, of the massaging member 1, and grips the handle 8, and puts fee on the pair of foot supports 7, the user can move his body forward and backward repeatedly in a reciprocating manner. By the reciprocating movement of the genitals of the user on the massaging plate 4, which gently contacts or massages the sphincter muscle of the user, the sphincter muscle can be trained, strengthened and energized, whereby the ability of the sphincter muscle (or genital) to perform sexual or other function are improved or revitalized.

Referring in detail to FIG. 3, a device 30 for massaging genitals (or genital areas) according to a second embodiment of the present invention includes a massaging member 1a, the basic plate 6 for supporting the massaging member 1a thereon through the plurality of supports 5, the handle 8 located at a higher end portion of the basic plate 3 compared with the massaging member 1a, the pair of foot supports mounted on the other end portion about the handle 8, and the massaging cover 4′ for fully covering on the massaging plate 4.

As shown in FIG. 3, the massaging member 1a has the opening 2, a plurality of springs 11 connected between the top surface of the opening 2 and the bottom surface of the massaging plate 4, and a pair of spaces 13a disposed at front and back portions thereof for receiving a bolt 12 freely wherein the pair of bolts 13 are inserted into a pair of third apertures 13. Accordingly, when the user moves forward and backward in the reciprocating manner, the massaging plate 4 can elastically move, so as to massage gently.

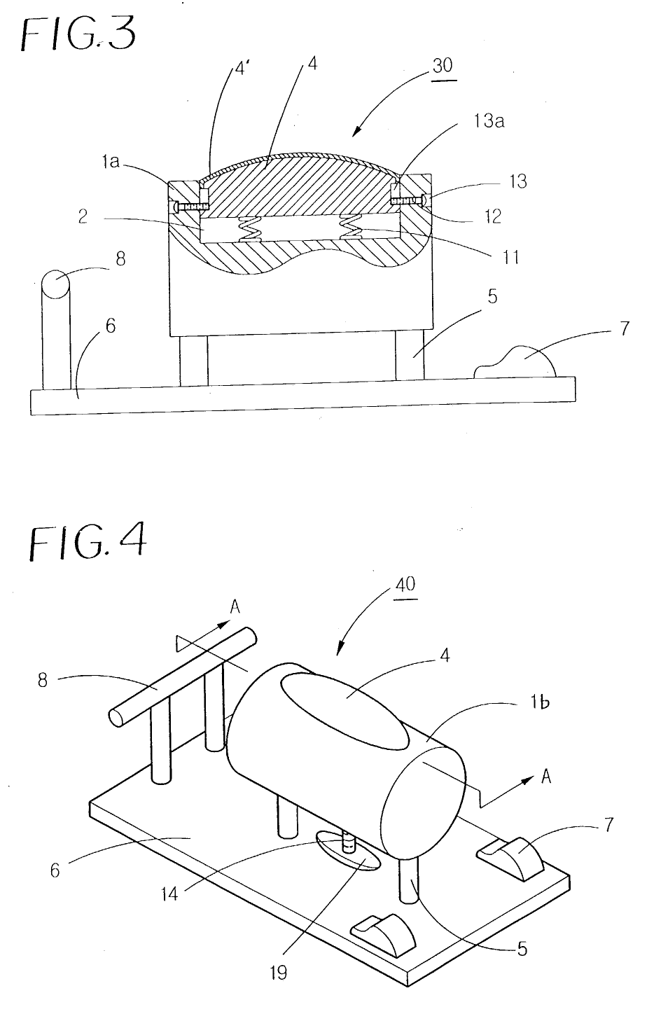

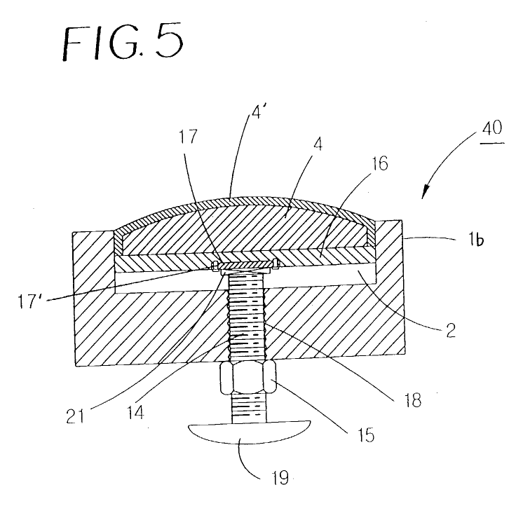

Referring in detail to FIGS. 4 and 5, a device 40 for massaging genitals (or genital area) according to a third embodiment of the present invention, includes a massaging member 1a, the basic plate 6 for supporting the massaging member 1a thereon, through the plurality of supports 5, the handle 8 located a higher end portion of the basic plate 3 compared with the massaging member 1a, the pair of foot supports mounted on other end portions, about the handle 8, and the massaging cover 4′ for fully covering on the massaging plate 4.

As shown in FIG. 5, the massaging member has the opening 2, a support plate 16 attached on the bottom surface of the massaging plate 4, a seat 17 attached to the support plate 16, a screw bolt 14 connected to the seat 17, at one end thereof, through an idling bearing 21 wherein the screw bolt 14 can be screwed through an inserting nut 18, has an end handle 19 disposed at the other end thereof, and passes through a conclusion nut 15 for adjusting the height of the massaging plate 4, according to the user's physical condition. When the user starts to exercise on the present devices 20, 30, and 40, usually, the user concentrates on one's weight, e.g., about 55 kg to 85 kg, to the massaging plate 4. Occasionally, the weight of the user can be lifted slightly from the massaging plate 4 for controlling friction between the massaging cover 4′ and the sphincter muscle of the user.

Although the user of the devices 20, 30 and 40 have been discussed to massage a genital area of a male, the present invention is not limited to such and is equally applicable, if desired, to the use of the device 20, 30 and 40 to massage a genital area or other area of a male, a female, or any entity in need of a massage.

Accordingly, the present invention provides a device and method of massaging a genital area (e.g., the sphincter muscle) of a user. By the use of the present invention, the user's sexual capacity/capability may be revitalized and improved significantly, and diseases such as urinary, premature ejaculation, anal fistulas, constipation, fatness and decline of energy can be prevented.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for massaging a body area of a user, the device comprising:
a basic plate;
a massaging member supported on the basic plate, the massaging member including;
an opening disposed in the massaging member;
a massaging plate disposed within the opening for smoothly joining with the top surface of the massaging member;;
whereby when the user makes user's body move in the reciprocating manner after the user sits on a portion of the massaging plate, the body area of the user is massaged by the massaging plate.

2. The device of claim 1, wherein the body area of the user is a genital area of the user.

3. The device of claim 2, wherein the genital area of the user includes a sphincter muscle of the user.

4. The device of claim 1, wherein the massaging member is supported on the basic plate through a plurality of supports.

5. The device of claim 1, wherein the engaging means includes:
a projection extended from the bottom surface of the massaging plate;
an opening disposed in the top surface of the massaging member for tightly receiving the projection;
a fixing rod; and
a first aperture disposed at the side surface of the massaging member and a second aperture disposed at the projection for fixingly receiving the fixing rod so as to smoothly join the massaging plate with the top surface of the massaging member, whereby the massaging plate can join with the top surface of the massaging member.

6. The device of claim 1, wherein the engaging means includes:
a plurality of springs attached to the bottom surface of the massaging plate;
an opening disposed in the top surface of the massaging member for elastically receiving the springs;
a pair of bolts for inserting into both side apertures disposed in both sidewalls of the massaging member;
front and rear spaces at both sidewalls of the massaging plate for flexibly receiving the bolts, whereby the massaging plate elastically engaged with the massaging member.

7. The device of claim 1, wherein the engaging means includes:
an opening disposed in the top surface of the massaging member;
a support plate attached on the bottom surface of the massaging plate;
a seat attached on the support plate;
a screw bolt connected to the seat at one end thereof through an idling bearing, the screw bolt being screwed through an inserting nut, having an end handle disposed at other end thereof, and passing through a conclusion nut for adjusting the height of the massaging plate according to the user's physical condition.

8. The device of claim 4, wherein the supports include two supports located on front and rear areas of the basic plate.

9. The device of claim 1, wherein each of the massaging member and the massaging plate have a curved top surface.

10. The device of claim 9, wherein the massaging plate includes a massaging cover on a top surface thereof for reducing friction between the massaging plate and the body area of the user.

11. The device of claim 1, wherein the massaging plate includes a cushion on a face of the massaging plate, to gently massage the body area of the user.

12. The device of claim 1, further comprising:
a handle disposed on the basic plate at one side thereof;
a pair of foot supports located on the basic plate at the other side thereof; and
a timer disposed in the vicinity of the handle.

13. A method of massaging a body area of a user, the method comprising:
sitting on a portion of a massaging plate of a massaging member supported on a basic plate;
gripping a handle supported on the basic plate;
putting a pair of feet on a pair of foot supports located on a basic plate;
moving the lower part of the body of the user on the massaging plate in a reciprocating manner; and
massaging the body area of the user by the movement of the massaging plate.

14. The method of claim 13, wherein the lower part of the body area of the user is a genital area, the genital area including a sphincter muscle of the user.

15. The method of claim 14, further comprising:
setting a timer after the gripping step to carry out the massaging step for a predetermined time duration.
